(19) United States
(12) Patent Application Publication
(10) Pub. No.: US 2024/0360853 A1
(43) Pub. Date: Oct. 31, 2024

(54) V-Shaped Frontal Fairing

(71) Applicants: Rodney H. Masters, Cypress, TX (US); Ross W. Flores, Richmond, TX (US)

(72) Inventors: Rodney H. Masters, Cypress, TX (US); Ross W. Flores, Richmond, TX (US)

(21) Appl. No.: 18/640,321

(22) Filed: Apr. 19, 2024

Related U.S. Application Data
(60) Provisional application No. 63/462,590, filed on Apr. 28, 2023.

(51) Int. Cl. F15D 1/10

(52) U.S. Cl. CPC F15D 1/10

(57) ABSTRACT

Embodiments of a fairing of the present invention generally include a V-shaped frontal geometry and linear or non-linear fins. In certain embodiments, the V-shaped frontal geometry is formed by the intersection of substantially linear frontal end segments, while in other embodiments the V-shaped frontal geometry is formed by the intersection of frontal end segments wherein one of both thereof are non-linear. Embodiments of a method of using embodiments of an apparatus of the present invention are also provided.

### CROSS-REFERENCE TO RELATED APPLICATIONS

This application claims the benefit of U.S. Provisional Application No. 63/462,590 filed on Apr. 28, 2023, which application is incorporated herein by reference as if reproduced in full below.

### STATEMENT REGARDING FEDERALLY SPONSORED RESEARCH OR DEVELOPMENT

Not Applicable.

### FIELD OF THE INVENTION

The present invention generally relates to a device for reducing fluid flow-induced vibration of structures, including underwater structures.

### BACKGROUND OF THE INVENTION

Risers, tendons, pipeline free-spans, power poles, electrical towers, electrical wind generation towers, traffic light poles and other elongated objects are subject to fluid flow. This fluid is typically fresh water, seawater and/or air. These elongated objects can comprise a substantially cylindrical geometry, such as offshore risers, offshore tendons, telephone poles, electrical towers, electrical wind generation towers, or these elongated objects may comprise a polygonal geometry, such as pentagonal, hexagonal etc., or any type of elongated geometry, hereinafter referred to as a cylindrical object.

When a fluid (air, water, etc.) flows past a cylindrical object, the inner-most fluid layer (i.e., the portion of the fluid that engages the object's exterior surface) slows down due to friction. The portion of fluid just distal thereto does not realize this friction and its flow past the object (i.e., “downstream”) is characterized as “spinning off” from this inner layer. This fluid spin off forms a “whirlpool,” known as a vortex eddy. This vortex eddy creation is consistent throughout the length of the cylindrical object that is subject to the fluid flow. The thus created eddies, which are generated on both pathways around the cylindrical object, comprise pockets of negative pressure. If these pockets of negative pressure are created simultaneously symmetrically (i.e., equivalently at the same time on both fluid pathways downstream), the cylindrical object typically experiences no fluid fluid-induced vibration. If, however, the rate of fluid flow is sufficiently high, the eddies created can be unsymmetrical, i.e., at alternating intervals, which are known as the “eddy frequency.” In one aspect, such high fluid flow can create alternating pockets of negative pressure downstream of the cylindrical object. This phenomenon is referred to as vortex shedding. Importantly, vortex shedding induces vibration of cylindrical objects subjected thereto. Such vibration is generally detrimental with respect to the cylindrical object, through resulting stresses, reduced fatigue life and/or structural failure.

In marine environments, the problem of degradation of cylindrical objects by vortex-induced vibration caused by fluid (e.g., air or seawater) flow can be addressed by utilizing vortex strakes or fairings. Vortex strakes, such as disclosed in U.S. Pat. No. 6,019,549 to Blair et al., can be employed to reduce vortex shedding, however, utilization thereof results in increased drag forces on the cylindrical object. Use of a fairing, on the other hand, can achieve a reduction in vortex shedding with a decrease in drag forces. In one aspect, such a fairing comprises a structure attached about the elongated object to streamline the flow of fluid around the object. Exemplary uses of fairings in marine environments may be found in U.S. Pat. No. RE48,123 to Masters et al., U.S. Pat. No. 8,834,070 to Masters et al., U.S. Pat. No. 8,579,546 to Masters et al., U.S. Pat. No. 7,934,888 to Masters et al., U.S. Pat. No. 7,674,074 to Masters et al., U.S. Pat. No. 7,337,742 to Masters et al. and U.S. Pat. No. 6,401,646 to Masters et al., each of which is incorporated herein by reference in its entirety.

While existing fairing technology in marine environments has proven beneficial, there still exist detrimental effects due to drag forces and/or other vibrations experienced by the cylindrical object. Accordingly, it would be desirable to provide a fairing that would further reduce such drag forces.

### BRIEF SUMMARY OF THE INVENTION

Embodiments of an apparatus of the present invention generally include a fairing comprising a substantially V-shaped frontal geometry. In certain embodiments, the V-shaped frontal geometry is formed by the intersection of substantially linear frontal end segments, while in other embodiments the V-shaped frontal geometry is formed by the intersection of frontal end segments wherein one or both of the fairing segments are non-linear. Embodiments of a method of using embodiments of an apparatus of the present invention are also provided.

### BRIEF DESCRIPTION OF THE DRAWINGS

For a more complete understanding of the present invention, reference is now made to the accompanying drawings, in which:

FIGS. 1 and 2 are depictions of prior art marine fairings.

FIG. 3 is a depiction of an embodiment of a fairing of the present invention wherein the V-shaped frontal section comprises the intersection of two substantially linear fairing frontal end segments.

FIG. 4 is a depiction of another embodiment of a fairing of the present invention wherein the V-shaped frontal section comprises the intersection of two substantially linear fairing frontal end segments.

FIG. 5 is a depiction of an embodiment of a fairing of the present invention wherein the V-shaped frontal section comprises the intersection of two substantially non-linear fairing frontal end segments.

FIG. 6 is a is a depiction of another embodiment of a fairing of the present invention wherein the V-shaped frontal section comprises the intersection of two substantially non-linear fairing frontal end segments.

FIG. 7 is a front perspective depiction of an embodiment of a fairing of the present invention.

FIG. 8 is a rear perspective depiction of an embodiment of a fairing of the present invention.

FIG. 9 is a rear depiction of an embodiment of a fairing of the present invention.

FIG. 10 is a rear perspective depiction of an embodiment of a fairing of the present invention.

FIG. 11 is a rear depiction of an embodiment of a fairing of the present invention.

### DETAILED DESCRIPTION OF EXEMPLARY EMBODIMENTS OF THE INVENTION

The exemplary embodiments are best understood by referring to the drawings, like numerals being used for like and corresponding parts of the various drawings. In the following description of embodiments, orientation indicators such as “top,” “bottom,” “up,’ “down,” “upper,” “lower,” “front,” “back,” etc. are used for illustration purposes only; the invention, however, is not so limited, and other possible orientations are contemplated.

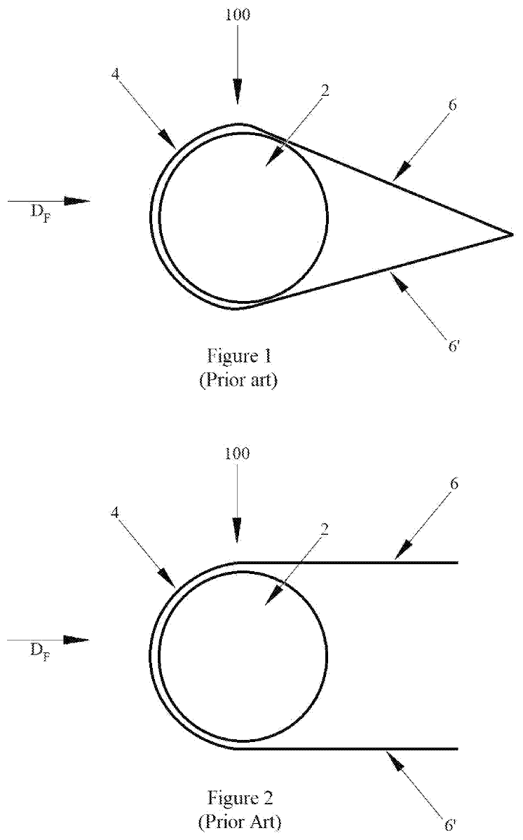

Referring first to FIGS. 1 and 2, two examples of prior art marine fairings comprising conventional U-shaped frontal geometries are depicted. In FIGS. 1 and 2 (as well as other Figures herein), D_{F} represents the direction of fluid flow encountered by the fairing-equipped cylindrical object 2, and the term “downstream,” as used herein, represents the relationship between objects with respect to D_{F}, as would be understood by one skilled in the art. In FIG. 1, the fairing 100 is engaged with a cylindrical object 2. The fairing 100 comprises a substantially round frontal component 4. The fairing 100 further comprises fins 6 and 6′, which terminally intersect downstream of the cylindrical object 2. In FIG. 2, the fairing 100 is engaged with a cylindrical object 2. The fairing 100 comprises a substantially round (or other relatively blunt) frontal component 4. The fairing 100 further comprises fins 6 and 6′, which extend substantially parallel to each other downstream of the cylindrical object 2.

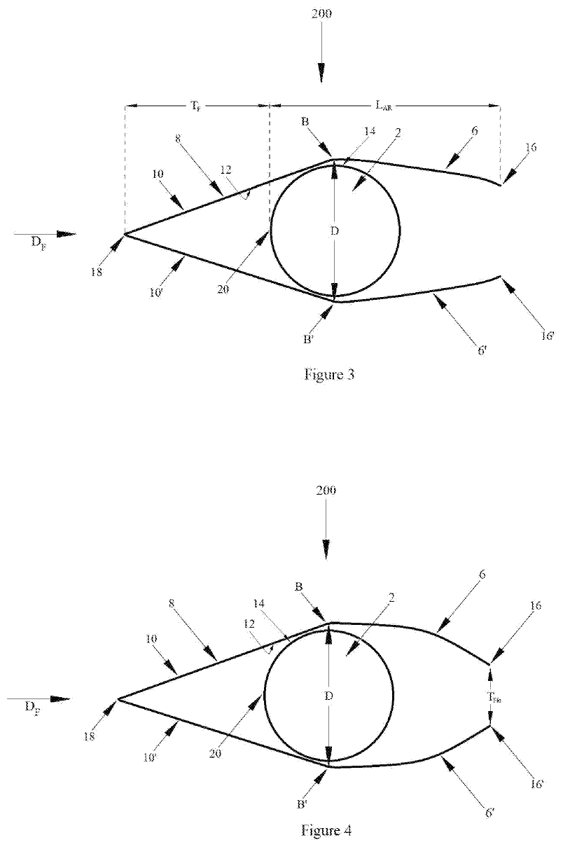

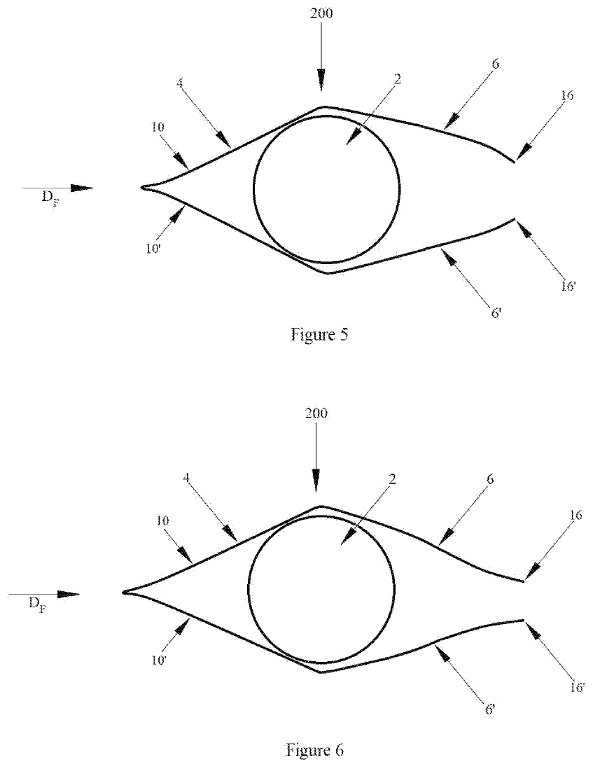

Referring now to FIG. 3, an embodiment of a fairing 200 of the present invention is depicted. Importantly, while herein fairing 200 is sometimes referred to as a marine environment fairing, the invention is not so limited and embodiments of a fairing 200 may be employed with other substantially cylindrical objects, such as power line poles, telephone poles, electrical towers, electrical wind generation towers, telecommunication antenna, traffic signals (both vertically and horizontally oriented), windmill towers and the like, as would be understood by ones skilled in the art. In one embodiment, fairing 200 comprises a closed, pointed frontal end 8. In certain embodiments, a fairing 200 frontal end 8 may comprise a substantially V-shaped geometry terminating in a leading edge 18, as depicted in FIG. 3; however, the invention is not so limited and other pointed frontal end 8 geometries may be employed. (See, e.g., FIGS. 5 and 6). In various embodiments, a pointed frontal end 8 may be formed by the intersection of frontal end segments 10 and 10′. In various embodiments, frontal end segments 10 and 10′ may comprise separate components that are attached at the pointed end of frontal end 8, or a fairing 200 may comprise frontal end segments 10 and 10′ that are integrally associated, i.e., frontal end segments 10 and 10′ forming a pointed end of frontal end 8 may comprise an integrated unit.

Also depicted in FIG. 3 are fins 6 and 6′, which extend downstream of cylindrical object 2. In certain embodiments, fin 6 is attached to frontal end segment 10 and/or fin 6′ is attached to frontal end segment 10′, at bend points “B” and B′”, respectively. In other embodiments, fin 6 and frontal end segment 10 comprise an integrated unit and/or fin 6′ and frontal end segment 10′ comprise an integrated unit.

In the embodiment of FIG. 3, the fins 6 and 6′ are substantially linear extending from bend points “B” and B′”, respectively, but curve proximate endpoints thereof 16 and 16′, respectively, although the invention is not so limited and one or both of fins 6 and 6′ may comprise a linear or other non-linear geometry. In addition, although the fins 6 and 6′ depicted in the embodiment of FIG. 3 are substantially symmetrically oriented with respect to each other, the invention is not so limited and a fairing 200 comprising substantially linear or non-linear fins 6 and 6′ may have such fins non-symmetrically oriented.

In various embodiments, a fairing 200 may comprise components comprising materials such as, but not limited to, polymers, fiberglass, carbon fibers, metals, wood, foams and/or rubbers. In one embodiment, the material of construction of at least a portion of a fairing 200 may comprise a molded polyethylene. In various embodiments, fins 6 and 6′ may comprise any useful thickness (not separately labeled), as would be understood by one skilled in the art. In one embodiment, a fairing 200 comprises fins 6 and 6′ comprising a thickness of about 0.15 inches to about 0.375 inches proximate their endpoints 16 and 16′, respectively. A fin 6 or 6′ may comprise a uniform thickness throughout, or the thickness of a fin may be nonuniform there along.

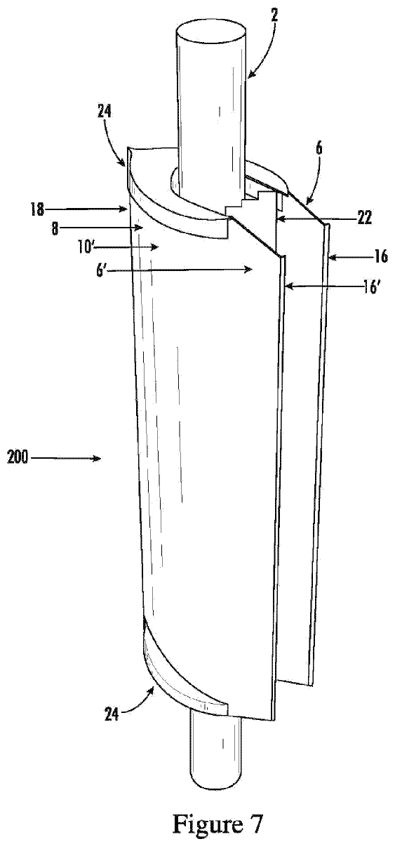

In one aspect, embodiments of a fairing 200 may comprise a backside retainer assembly (shown in FIGS. 7-9), as is well known within the field of invention, that maintains the engagement between the fairing 200 and the cylindrical object 2. In another aspect, embodiments of a fairing 200 may comprise a spacing (not separately labeled) between the interior surface 12 of the fairing 200 and the exterior surface 14 of the cylindrical object 2, as shown in the embodiment of FIG. 3. In one aspect, such spacing allows the fairing 200 to “weathervane” about the cylindrical object 2, such that upon change in the D_{F}, the fairing 200 maintains an operational orientation (i.e., parallel to D_{F}) with respect to the cylindrical object, as would be understood by one skilled in the art.

Also depicted in the embodiment of FIG. 3 are relative dimensions of various aspects of certain embodiments of a fairing 200. In one aspect, a frontal taper distance T_{F} designates the distance between the upstream (leading) edge 18 of fairing 200 frontal component 10, and the upstream edge 20 of exterior surface 14 of cylindrical object 2, and D designates the diameter of the fairing 200 body. In one embodiment, a fairing 200 comprises a T_{F} that is equal to about 0.5 D to about 1.0 D, although the invention is not so limited and other ratios of T_{F} to D may be employed. In another aspect, an aspect ratio distance L_{AR} designates the distance between upstream edge 20 and the end of the fins 6 and/or 6′. In one embodiment, a fairing 200 comprises an L_{AR} that is equal to about 1.5 D to about 2.0 D, although the invention is not so limited and other ratios of L_{AR} to D may be employed. In various embodiments, the relative dimensions of the various sections of a fairing 200 may depend on certain factors, including, but not limited to, the diameter of cylindrical object 2, the length and/or angle of deflection (if any) of fins 6 and 6′, and the anticipated velocity of fluid flow, as would be understood by one skilled in the art.

FIG. 4 depicts another embodiment of a fairing 200 of the present invention. In the embodiment of FIG. 4, the fins 6 and 6′ are disposed in a non-parallel orientation. In the embodiment of FIG. 4, the fins 6 and 6′ are substantially curved extending from bend points “B” and B′”, respectively, although the invention is not so limited and one or both of fins 6 and 6′ may comprise a linear or other non-linear geometry. In the embodiment of FIGS. 3 and 4, the fins 6 and 6′ are tapered and/or curved inward (i.e., toward an axis (not separately labeled) extending through upstream (leading) edge 18 and the center of the cylindrical object 2 with respect to bend points B and B′, although the invention is not so limited and one or both of fins 6 and 6′ may be tapered and/or curved outward. In one embodiment, the tapering of fins 6 and 6′ is such that the fin endpoints 16 and 16′ are disposed apart by a tapering distance T_{Fin} (shown in FIG. 4), such that T_{Fin} is greater than or equal to one half of the diameter D of the fairing 200 body.

Referring now to FIGS. 5 and 6, additional embodiments of a fairing 200 are depicted. In these embodiments, frontal end 8 comprises contoured frontal end segments 10 and 10′. As can be seen in FIGS. 5 and 6, the orientation of fins 6 and 6′ are non-linear and inwardly tapered/curved. In the embodiment shown in FIG. 6, the fins 6 and 6′ of the fairings 200 may comprise a “double curved” geometry. In one aspect, the curvature of contoured frontal end segments 10 and 10′ may be varied so as to provide desired fluid drag and/or vibration characteristics of the fairing 200, as would be understood by one skilled in the art.

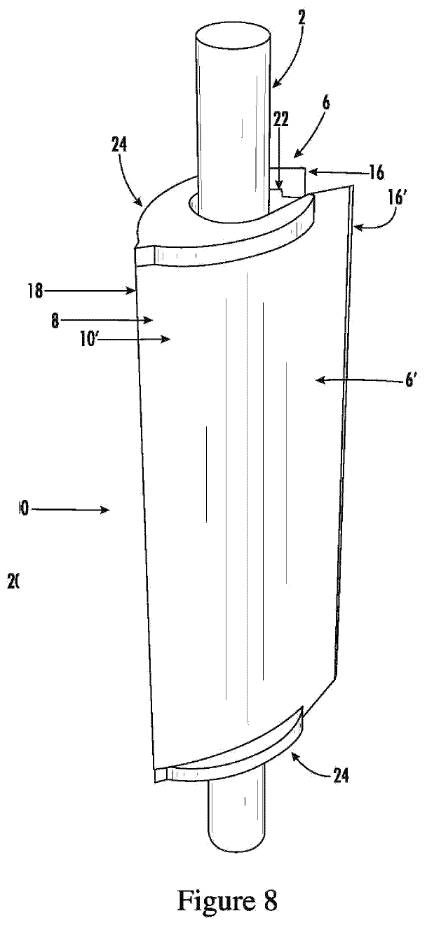

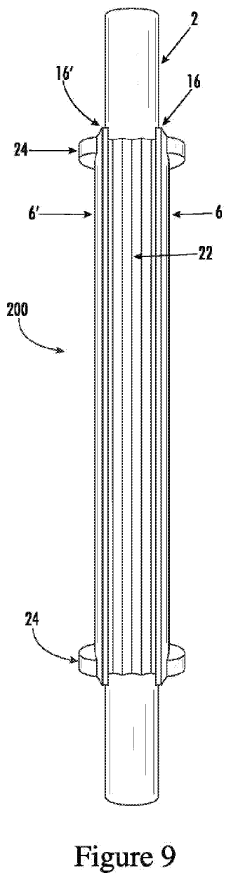

Shown in FIGS. 7-9 are various embodiments of a fairing 200 positioned about a cylindrical object 2. In FIG. 7, a front perspective view of a fairing 200 embodiment engaged with a cylindrical object 2 is depicted. In certain embodiments, such as those depicted in FIGS. 7-9, a fairing 200 may comprise one or more flanged endpieces 24 which are useful for interacting with flange collars (not shown) that may be engaged with the cylindrical object 2 proximate a fairing 200 disposed thereon, as would be understood by one skilled in the art, although the invention is not so limited and other components may be used to interact with flange collars if that is desired. In FIG. 8, a rear perspective view of a fairing 200 embodiment engaged with a cylindrical object 2 is depicted. In FIG. 9, a rear view of a fairing 200 embodiment engaged with a cylindrical object 2 is depicted. Identified in FIGS. 7-9 is a backside retainer assembly 22, which may comprise a standard such component as is commonly used within the industry.

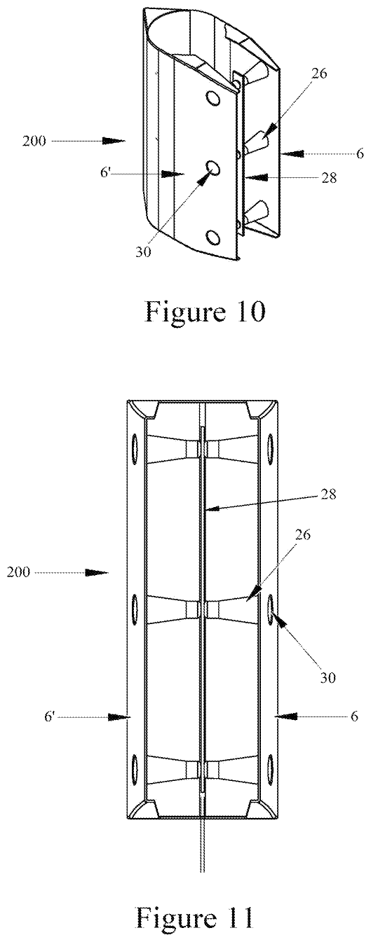

Various means may be employed for securing a fairing 200 about a cylindrical object 2, as would be understood by one skilled in the art. In one aspect, such securement may be achieved by fastening fins 6 and 6′ together. Examples of such means may be found in U.S. Pat. Nos. RE48,123 and 8,834,070 to Masters et al. In one embodiment of the present invention, as shown in FIGS. 10 and 11, a fairing 200 may comprise one or more “internal cones” 26 that facilitate securement of fin 6 to fin 6′. In one embodiment, an internal cone 26 may comprise a substantially annular member through which a fastening component, such as, but not limited to, a bolt (not shown), may be therethrough inserted. In various embodiments, an internal cone 26 may be molded into the fin 6 and/or 6′ during manufacturing thereof, or may be affixed to a fin 6 and/or 6′, integral with or removably attachable thereto, after the fin 6 and/or 6′ is produced. In one embodiment, the fastening of a fin 6 to a fin 6′ comprises utilizing one or more vertical connection plates 28, although the invention is not so limited and other means of providing a connection means between adjacent internal cones 26 may be employed. In one embodiment (not shown), no connection means between adjacent internal cones 26 is employed. In the embodiment depicted in FIGS. 10 and 11, the vertical connection plate 28 extends substantially the length of the fairing 200, although the invention is not so limited and other relative dimensions may be employed.

In one embodiment, connection of fins 6, 6′ may be achieved by inserting a bolt (not shown) into a fin 6 orifice 30 and extending the bolt through the adjacent internal cone 26, whereupon the bolt is extended through an orifice (not visible in FIGS. 10 and 11) in the vertical connection plate 28 and through a corresponding fin 6′ internal cone 26 and adjacent orifice 30. Once the bolt is so disposed, nuts (not shown) are employed at either end of the bolt. In one embodiment (not shown), one or more washers may be employed along the length of the bolt, which may enhance shear strength and/or bearing strength of the material(s) which the internal cones 26 comprise. In one such embodiment, one or more washers may be employed between an internal cone 26 and the vertical connection plate 28 connected thereto. In one embodiment, once the fins 6 and 6′ are thus secured, various surfaces of the connection mechanism, e.g., washers and nuts, may be coated with a sealant, such as, but not limited to, an encapsulating rubber spray, to prevent loosening of thereof.

### Operation

Generally, an embodiment of employing one or more fairings 200 comprises engagement thereof with a cylindrical object 2. As noted above, a cylindrical object 2 may comprise a marine (at least partially subsea) object, although the invention is not so limited and embodiments of a fairing 200 may be employed with other substantially cylindrical objects, both marine and non-marine, as would be understood by one skilled in the art. In one embodiment, a cylindrical object 2 is fitted with at least one fairing 200 on at least a portion thereof, such that the fairing(s) 200 are oriented with respect to the direction of fluid flow (DF) such that the fluid flow engages frontal end 8 of the fairings 200. In certain embodiments, the fairing(s) 200, when engaged with the cylindrical object 2, are spaced apart therefrom such that a change in DF effects a reorientation of the fairing(s) 200 about the cylindrical object 2 (i.e., the fairing(s) 200 rotate about the cylindrical object 2 in a “weathervane” manner) whereby the fairing(s) 200 remain suitably oriented so as to achieve the purpose of reducing vibration experienced by the cylindrical object 2 due to fluid flow.

### Method

An exemplary method of utilizing an embodiment of a fairing of the present invention comprises:
A Cylindrical Object Provision Step, comprising providing a substantially cylindrical object, such as cylindrical object 2; and
A Fairing Equipment Step, comprising providing a fairing, such as fairing 200, about at least a portion of the cylindrical object.

The foregoing method is merely exemplary, and additional embodiments of methods of providing protection of a substantially cylindrical object by a fairing of the present invention consistent with the teachings herein may be employed. In addition, in other embodiments, one or more of these steps may be performed concurrently, combined, repeated, re-ordered, or deleted, and/or additional steps may be added.

The foregoing description of the invention illustrates exemplary embodiments thereof. Various changes may be made in the details of the illustrated construction and process within the scope of the appended claims by one skilled in the art without departing from the teachings of the invention. Disclosure of existing patents, publications, and/or known art incorporated herein by reference is to the extent required to provide details and understanding of the disclosure herein set forth. The present invention should only be limited by the claims and their equivalents.

We claim:

1. A fairing comprising:
a leading-edge portion having a substantially V-shaped frontal geometry;
a pair of opposing frontal end segments intersectingly terminating at a first end thereof in said V-shaped leading-edge frontal geometry; and
a pair of opposing fins, each terminating at a first end thereof at a second end of one of said frontal end segments;
wherein the confines of said fairing provide a longitudinal gap wherein an elongated object may be positioned therein substantially axially to said fairing.

2. The fairing of claim 1, wherein a second end of at least one said fin is closer to a centered longitudinal axis of said fairing, said longitudinal axis bisecting the terminating intersection of said frontal segments, than it is to said centered longitudinal axis where said fin terminates at said second ends of said frontal end segment.

3. The fairing of claim 1, comprising a frontal taper distance T_{F} and a fairing body diameter D, wherein T_{F} is equal to about 0.5 D to 1.0 D.

4. The fairing of claim 1, comprising an aspect ratio distance L_{AR} and a fairing body diameter D, wherein L_{AR} is equal to about 1.5 D to 2.0 D.

5. The fairing of claim 1, wherein a second end of at least one said fin comprises a curved geometry proximate a second end thereof.

6. The fairing of claim 1, wherein least one said fin comprises a curved geometry along substantially the entire length thereof.

7. The fairing of claim 2, wherein the second ends of said fins are disposed apart by a tapering distance T_{FIN}, such that T_{FIN} is greater than or equal to one half a fairing body diameter D.

8. A fairing comprising:
a leading-edge portion having a contoured, pointed frontal geometry;
a pair of opposing frontal end segments intersectingly terminating at a first end thereof in said contoured, pointed leading-edge frontal geometry; and
a pair of opposing fins, each terminating at a first end thereof at a second end of one of said frontal end segments;
wherein the confines of said fairing provide a longitudinal gap wherein an elongated object may be positioned therein substantially axially to said fairing.

9. The fairing of claim 8, wherein a second end of at least one said fin is closer to a centered longitudinal axis of said fairing, said longitudinal axis bisecting the terminating intersection of said frontal segments, than it is to said centered longitudinal axis where said fin terminates at said second ends of said frontal end segment.

10. The fairing of claim 8, comprising a frontal taper distance T_{F} and a fairing body diameter D, wherein T_{F} is equal to about 0.5 D to 1.0 D.

11. The fairing of claim 8, comprising an aspect ratio distance L_{AR} and a fairing body diameter D, wherein L_{AR} is equal to about 1.5 D to 2.0 D.

12. The fairing of claim 8, wherein a second end of at least one said fin comprises a curved geometry proximate a second end thereof.

13. The fairing of claim 8, wherein least one said fin comprises a curved geometry along substantially the entire length thereof.

14. The fairing of claim 9, wherein the second ends of said fins are disposed apart by a tapering distance T_{FIN}, such that T_{FIN} is greater than or equal to one half a fairing body diameter D.

15. A method of employing a fairing, comprising:

1. ng the fairing of claim 1 substantially circumferentially about at least a portion of an elongated object; and
exposing at least the portion of the elongated object that is equipped with said fairing to fluid flow.

16. The method of employing a fairing of claim 10, wherein the fluid comprises water.

17. The method of employing a fairing of claim 10, wherein said elongated object comprises a marine object.

18. A method of employing a fairing, comprising:
providing the fairing of claim 8 substantially circumferentially about at least a portion of an elongated object; and
exposing at least the portion of the elongated object that is equipped with said fairing to fluid flow.

19. The method of employing a fairing of claim 18, wherein the fluid comprises water.

20. The method of employing a fairing of claim 18, wherein said elongated object comprises a marine object.
